(19) United States
(12) Patent Application Publication
(10) Pub. No.: US 2004/0047532 A1
(43) Pub. Date: Mar. 11, 2004

(54) Polarisation beam splitters/combiners

(76) Inventor: Ivan Evans, Oxford (GB)

Correspondence Address: Mark D Saralino, Renner Otto Boiselle & Sklar, 19th Floor, 1621 Euclid Avenue, Cleveland, OH, 44115, US

(21) Appl. No.: 10/415,929

(22) PCT Filed: Nov. 7, 2001
(86) PCT No.: PCT/GB01/04943

(30) Foreign Application Priority Data
Nov. 8, 2000 (GB) 0027227.8

(51) Int. Cl. G02B 6/00; G02B 6/26

(52) U.S. Cl. 385/11; 385/44

(57) ABSTRACT

A polarisation beam splitter (1) comprises a substrate (2) and a branched waveguide (3) formed on top of the substrate (2) and having a main portion (4) and two branch portions (5) and (6) with gradual splitting angles relative to the main portion (4) for conducting respective polarisation components along respective axes. One of the branch portions (5) is formed with a dielectric coating (7) in the region in which the branch portion (5) splits off from the main portion (4). The dielectric coating (7) serves to stress or de-stress the branch portion (5) in the region of the branching junction relative to the branch portion (6), such that different polarisation components in the main portion (4) are split apart along respective branch portions (5) and (6) by the resulting differential birefringence. Such an arrangement, which may also be applied to a combiner, is advantageous since it provides efficient splitting of polarisation components and is easily fabricated.

The present invention relates to polarisation beam splitters and combiners, and is concerned more particularly, but not exclusively, with integrated optical waveguide splitters and combiners for use in optical communication systems.

In integrated optical circuits light is typically transmitted down waveguides formed in materials such as silicon, other semiconductors or silica. A silicon waveguide structure typically comprises a rib formed in the upper epitaxial silicon layer of a SOI (silicon-on-insulator) chip. The rib has a top surface and side walls, and serves to confine an optical transmission along the waveguide structure.

It is often desirable to modify the basic waveguide structure to perform a number of different functions, for example to spatially separate orthogonal polarisation components, such as TE and TM components, or to spatially combine together such components. Integrated polarisation beam splitters and combiners are known. “An integrated optic adiabatic TE/TM mode splitter in Silicon”, R. D. de Ridder, A. F. M. Sander, A. Driessen, J. H. Fluitman, IEEE J. of Lightwave Technology, vol. 11, no. 11, p. 1806, 1993 discloses a polarisation beam splitter in a silicon oxynitride on silicon material system having an asymmetric layered Waveguide structure which relies on shape birefringence to introduce a different sign of birefringence each branch of the Y junction.

However such devices typically rely on the use of carefully tailored multilayer structures to achieve the desired shape birefringence, and it is difficult to envisage how such a layered structure could be achieved in a SOI waveguide without losing many of the advantages of SOI fabrication. It might be possible to utilise cladding layers on top of the waveguide, but suitable materials with sufficiently high refractive indices are not readily available, and metal cladding layers may give a substantial optical loss.

It is an object of the invention to provide a polarisation beam splitter or combiner which may be formed in a straightforward manner during fabrication of an integrated device based on SOI technology, for example.

According to the present invention there is provided a polarisation beam splitter/combiner comprising a substrate, a branched waveguide formed on the substrate and having a main portion and two branch portions for conducting respective polarisation components along respective axes, and polarisation splitting/combining means for splitting apart or combining together of different polarisation components conducted along respective branch portions, wherein the polarisation splitting/combining means comprises stress-controlling means associated with at least one of the branch portions providing differential stressing of the branch portions such that the splitting apart or combining together of the different polarisation components is caused by the resulting differential birefringence.

Such a device is advantageous since it provides efficient splitting of polarisation components and is easily fabricated.

Preferred and optional features of the invention will be apparent from the subsidiary claims of the specification.

For a better understanding of the present invention and to show how the same may be carried into effect, reference will now be made, by way of example, to the accompanying drawings in which:

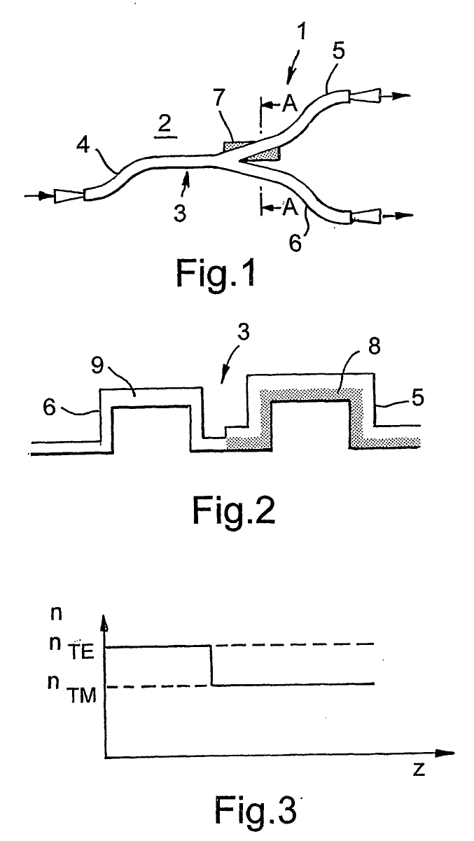

FIG. 1 is a schematic diagram illustrating a splitter according to the invention in plan view;

FIG. 2 is a cross-section taken along the line A-A in FIG. 1;

FIG. 3 is a graph of the refractive index across the cross-section of FIG. 2;

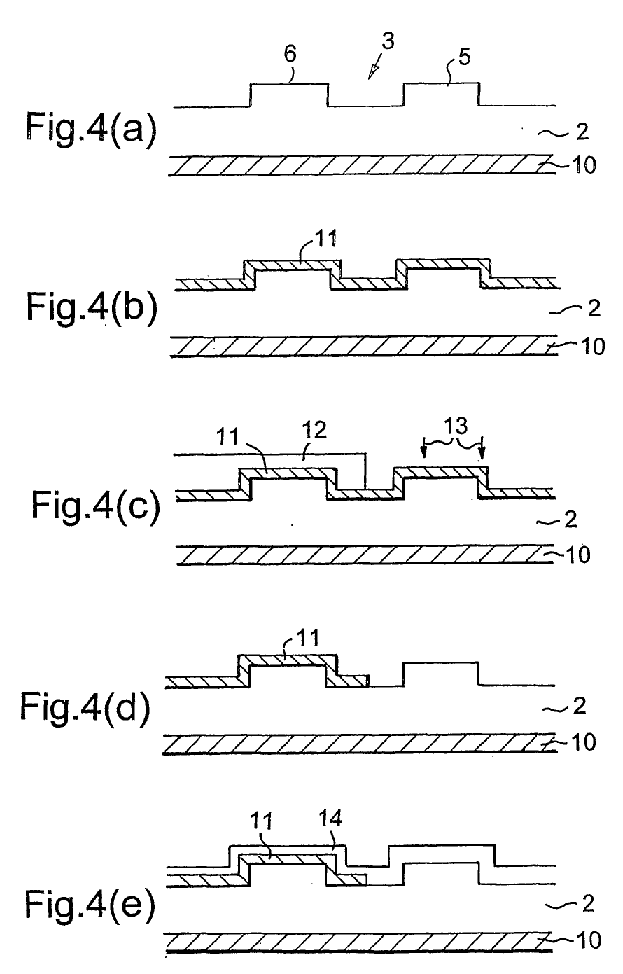

FIGS. 4(a) to 4(e) are explanatory diagrams illustrating a first method of fabrication of the splitter; and

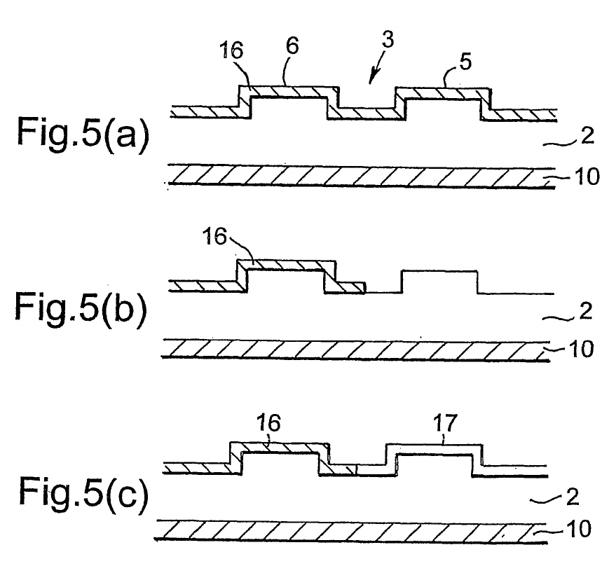

FIGS. 5(a) to 5(c) are explanatory diagrams illustrating a second method of fabrication of the splitter.

FIG. 1 diagrammatically shows a polarisation beam splitter 1 comprising a slab region 2 and a Y-branching waveguide structure 3 formed on top of the region 2 and having a main waveguide portion 4 and two branch waveguide portions 5 and 6 with a gradual splitting angle. (typically between 0.02 and 0.4 degrees depending on the device parameters) relative to the main portion 4 for conducting respective polarisation components along respective axes.. The two branch portions 5 and 6 are arranged to be asymmetric, by the application of stress as will be described below, so as to apply birefringence of opposite sign to the light in each portion 5, 6. To this end one of the branch portions 5 is formed with a stressed dielectric coating 7 in the region in which the branch portion 5 splits off from the main portion 4, whereas no such dielectric coating is provided in the corresponding region of the other branch portion 6. The dielectric coating 7 serves to stress or de-stress the branch portion 5 in the region of the branching junction relative to the branch portion 6 in the region of that junction. Alternatively, instead of the dielectric coating 7, such stressing or de-stressing may be produced by the absence in the vicinity of the junction of part of a dielectric coating which is applied to the remainder of the waveguide.

The birefringence is the difference between the effective refractive indices for the TE and TM polarisation components, and can be considered as having two constituents, namely (i) waveguide (or shape) birefringence which is caused by the asymmetry of the waveguide geometry, in this case the rib/ridge waveguide, and (ii) material birefringence which is related to the symmetry of the crystal structure. For example, in a symmetric structure like silicon, the material birefringence should be zero. However the application of stress can break the symmetry of the crystal lattice. The essence of the splitter 1 described is that the birefringence in the branch portion 5 has a different sign to the birefringence in the branch portion 6.

If the waveguide branching angle is suitably designed to form an adiabatic junction, an efficient polarisation splitter is obtained as the power remains in the fundamental mode throughout.

FIG. 2 shows a cross-section taken along the line A-A in the vicinity of the junction of the waveguide 3 shown in FIG. 1 showing the branch portion 5 incorporating a silicon oxide layer 8 which is missing from the branch portion 6, both branch portions 5 and 6 being coated with a silicon nitride layer 9.

As shown in the graph of FIG. 3 of the refractive index n against distance z across the cross-section of FIG. 2, the stress-inducing silicon oxide layer 8 causes stressing of the branch portion 5 relative to the branch portion 6, thereby inducing birefringence such that the refractive index for a given polarisation state in branch portion 5 differs substantially from the refractive index in the branch portion 6. Typically a refractive index difference of 0.0005 or more would be sufficient. The splitter should be designed such that the refractive index difference for the TE polarisation component is of opposite sign to the refractive index difference for the TM polarisation component. In other words, if the branch portion 5 has a higher refractive index than the branch portion 6 for TE excitation, then the branch portion 5 should be designed to have a lower refractive index than the branch portion 6 for IM excitation.

A brief description will now be given, with reference to FIG. 4, of the fabrication steps which may be used in a first method of fabrication of such a splitter in a SOI structure. Initially the waveguide 3 with the branch portions 5 and 6 is formed in an epitaxial layer 2 on a silicon substrate having a buried silicon dioxide layer 10. The necessary ribs are formed in the layer 2 by masking and etching in known manner to produce the structure shown in FIG. 4(a). A layer 11 of silicon oxide is then formed over the ribs by thermal oxidation to produce the structure shown in FIG. 4(b). This oxidation process may either be a wet oxidation process in which the substrate is heated in a wet oxygen-containing atmosphere resulting in a reaction with the steam, or a dry oxidation process in which the substrate is heated in a dry oxygen-containing atmosphere. Preferably a wet oxidation process is used with an oxidation temperature in the range of 700 to 1200 degrees and an oxidation time in the range of 0.2 to 10 hours.

A mask 12 is then selectively applied on top of the silicon oxide layer 11 as shown in FIG. 4(c), in order to define a window in the region of the branch portion 5. Wet or dry etching is then effected through the window, as shown by the arrows 13 in FIG. 4(c), in order to remove the silicon dioxide layer 11 in that window to produce the structure as shown in FIG. 4(d) after removal of the mask 12. Finally a layer 14 of silicon nitride or silicon oxynitride is applied over both branch portions 5 and 6 using a LPCVD (low pressure chemical vapour deposition) process or a PECVD (plasma enhanced chemical vapour deposition) process to produce the structure shown in FIG. 4(e). In the LPCVD process, the silicon nitride (Si₃N₄) is formed by the reaction of silane (SiH₄) and ammonia (NH₄) at temperatures of typically 700-900° C. In the PECVD process, the silicon nitride/oxynitride (SiOₓN_{y}) is formed by the reaction of silane (SiH₄), ammonia (NH₄) and nitrous oxide (N₂O) in a plasma at temperatures of typically 250-350° C.

A second method of producing the splitter in accordance with the invention will now be described with reference to FIG. 5, with reference mainly being made to those steps which differ from the method already described with reference to FIG. 4. initially a layer 16 of silicon nitride is deposited on the branch portions 5 and 6 by a LPCVD process to produce the structure shown in FIG. 5(a). Using similar masking and etching techniques to those described above with reference to FIG. 4(c), part of the silicon nitride layer 16 in a window overlying the branch portion 5 in the vicinity of the junction is removed to produce the structure as shown in FIG. 5(b). Finally a layer 17 of silicon oxide is produced by thermal oxidation in the region in which the silicon nitride layer 16 has previously been removed, with the silicon nitride layer 16 suppressing thermal oxidation of the remainder of the surface, in order to produce the structure shown in FIG. 5(c).

In the first of the above methods the silicon oxide layer 11 applies tensile stress to the waveguide 3, whilst the silicon nitride layer 14 provides compressive stress. As a result the branch portion 5 in the vicinity of the junction is de-stressed with respect to the branch portion 6 of the waveguide 3.

In the second method the silicon oxide layer 16 applies tensile stress whilst the silicon dioxide layer 17 applies compressive stress; thus again de-stressing the branch portion 5 in the vicinity of the junction relative to the branch portion 6. The birefringence resulting from such differential stressing between the two branch portions 5 and 6 can be used to separate the TE and TM modes in the branch portions. Other combinations of dielectric coating and/or selective strip may be used to produce the required birefringence which requires only that different stresses are applied to the two branch portions of the waveguide.

It should be appreciated that the splitter described above is only one type of splitter to which the invention is applicable, and that the invention is also applicable to a wide range of further splitter types known to persons skilled in the art. For example the invention may be applied to an adiabatic splitter of the type known from R. Adar, C. H. Henry, R. F. Kazarinov, R. C. Kistler, G. Weber, “Adiabatic 3-dB couplers, filters and multiplexers made with silica waveguides on silicon”, IEEE Journal of Lightwave Technology, vol. 10, no.1, p. 46, January 1992.

Other embodiments of the invention utilise one or more of the following features: (i) stress releasing grooves, (ii) an undercut waveguide portion to enhance stress, (iii) films on both sides or film removal on one side of the substrate, (iv) annealing to relieve stress, (v) physical application of stress or pressure by a pressure plate pressing downwardly on the waveguide portion, and (vi) piezoelectric material (or a similar class of material which exhibits change in length when a voltage is suitably applied). With suitable design only one of the waveguide portions needs to be perturbed.

Various modifications of the above described manufacturing methods are possible within the scope of the invention. In particular the actual films used are not significant. Silicon oxide, silicon nitride and silicon oxynitride have been referred to above because of their ease of deposition onto silicon and compatibility with standard semiconductor processing techniques, but films of many other materials may also be used including dielectric materials such as CVD diamond/carbon, polysilicon, TEOS (tetraethylorthosilicate tetraethylorthosilicate, Si(OCH₂CH₃)₄), AlO₃, TiO₂ and other oxides. Other techniques, such as flame hydrolysis or spin coating, may be used to deposit glass coatings. Polymer coatings may also prove suitable. Metal films on silicon can also be used to produce the necessary stress effects. In addition crystaline semiconductor materials with a slight lattice mismatch may be grown on top of the silicon to produce similar stress effects. It is further contemplated that the required differential birefringence could be produced by use of asymmetrical silicon waveguides and/or partial metal loading.

The methods described may be equally applicable to other material systems, such as InP/InGaAsP, GaAs/AlGaAs, silica on silicon (or other substrates) or polymer waveguides. However, in these material systems, the waveguide structure is usually formed by laying down several layers, with slightly different compositions. In such systems it may be easier to utilise shape birefringence to design a suitable structure.

By contrast the method of applying stress may be useful in material systems with high refractive indices or where implementing a structure with tuned shape birefringence may be difficult because of lack of suitable materials or complexity of the processing required. In order to obtain the required stress the dielectric film is usually deposited on the substrate at elevated temperature so that, when the film and substrate cool, the resultant composite structure is placed under stress as a result of the different expansion coefficients of the film and the substrate. Stress in thermal oxide films is generally compressive, which will induce a tensile stress in the underlying silicon substrate. LPCVD silicon nitride, PECVD silicon oxynitride or sputtered silicon nitride generally show a high tensile stress, although this dependent on the deposition parameters. This will result in a compressive stress in the silicon.

The following are examples of different applications to which a device in accordance with the invention may be applicable.

(a) Improvement of polarisation performance of an arrayed waveguide grating (AWG) device The polarisation response of such a device may be improved through the use of a polarisation splitter in accordance with the invention at the device input. The method by which such improvement may be obtained is described in: “PHASAR-based WDM-devices: principles, designs and applications”, M. K Smit, C. Van Dam, IEEE J. Selected Topics in Quantum Electronics, vol. 2, no. 2, p. 236, 1996.

(b) Coherent detection system Coherent communication systems involve the mixing of a transmitted signal with a local oscillator at the receiver. Coherent detection allows a lower received power than other techniques. In order to mix the signals at the detector they must be polarised in the same plane. Therefore, if the incoming polarisation is unknown or varies, some form of polarisation splitter is required, and the device in accordance with the invention is particularly suitable for this purpose.

(c) Optical sensor applications fibre optical gyroscopes usually require some sort of polarisation element,

(d) Polarisation regenerator Such a device, with the addition of a polarisation rotator, may be used to regenerate a random polarisation input back to a known polarisation output without significant loss. This may be important for the previous two applications.

(e) Polarisation diversity In this scheme the polarisation dependence of an optical system is circumvented by splitting the two polarisation components and processing them separately.

(f) Polarisation state rotator If a polarisation rotator and such a splitter are combined in a 1×2 switch, an integrated variable polarisation rotator can be achieve.

(g) Polarisation loss dependent compensator Compensation of known PDL is possible by splitting, adjusting and subsequently recombining the polarisation components utilising such a splitter/combiner. More generally, a polarisation splitter could be used to compensate for the polarisation dependence of alnost any optical device or system.

(h) Polarisation mode dispersion (PMD) compensator. In future fibre transmission systems utilising bit rates of 10 Gbits/s and above PMD will become significant. PMD can be associated with either transmission along a length of fibre or through an optical component. The time constant associated with polarisation fluctuations in such systems is expected to be large. Active polarisation monitoring and compensation is therefore possible utilising such a splitter and could be incorporated into a receiver. With the use of the component described here the optical part of a PMD compensation could be integrated on to a single chip.

(i) Polarisation analyser: An Integrated polarisation analyser is possible utilising such a device, if photodiodes are hydridised onto the device to monitor the power in each branch.

(j) Broadband polarisation splitter The splitter should operate effectively over a wide bandwidth.

(k) Optical isolator The device in accordance with the invention is suitable for use in such an isolator.

(l) Polarisation dependent switch/router In a polarisation maintaining (PM) transmission system channels could be routed by polarisation state utilising such a splitter.

1. A polarisation beam splitter/combiner comprising a substrate (2), a branched waveguide (3) formed on the substrate (2) and having a main portion (4) and two branch portions (5, 6) for conducting respective polarisation components along respective axes, and polarisation splitting/combining means for splitting apart or combining together of different polarisation components conducted along respective branch portions (5, 6), wherein the polarisation splitting/combining means comprises stress-controlling means (7) associated with at least one of the branch portions (5, 6) providing differential stressing of the branch portions (5, 6) such that the splitting apart or combining together of the different polarisation components is caused by the resulting differential birefringence.

2. A polarisation beam splitter/combiner according to claim 1, wherein the stress-controlling means includes a stress-inducing coating (7) which causes stressing of one of the branch portions (5, 6).

3. A polarisation beam splitter/combiner according to claim 2, wherein the stress-controlling means (7) includes a further stress-inducing coating which causes stressing of the other branch portion to a different extent to said one branch portion.

4. A A polarisation beam splitter/combiner according to claim 2 or 3, wherein the stress-inducing coating (7) is a dielectric coating in the vicinity of one of the branch portions (5, 6) which causes stressing of said one branch portion.

5. A polarisation beam splitter/combiner according to claim 2 or 3, wherein the stress-inducing coating (7) is a lattice mismatched layer in the vicinity of one of the branch portions (5, 6) which causes stressing of said one branch portion.

6. A polarisation beam splitter/combiner according to any preceding claim, wherein the stress-controlling means (7) includes a region in the vicinity of one of the branch portions (5, 6) which has been prestressed by the application of an external force thereto.

7. A polarisation beam splitter/combiner according to any preceding claim, wherein the stress-controlling means (7) includes a material which changes its dimensions on the application of an electrical voltage in order to cause stressing of one of the branch portions (5, 6).

8. A polarisation beam splitter/combiner according to any preceding claim, wherein the stress-controlling means (7) is adapted to apply a temperature gradient in order to cause stressing of one of the branch portions (5, 6).

9. A polarisation beam splitter/combiner according to any preceding claim, wherein the stress-controlling means (7) includes at least one groove for relieving stress in the vicinity of one of the branch portions (5, 6).

10. A polarisation beam splitter/combiner according to any preceding claim, wherein the stress-controlling means (7) includes at least one undercut portion for enhancing stress in the vicinity of one of the branch portions (5, 6).

11. A polarisation beam splitter/combiner according to any preceding claim, wherein the form of the waveguide (3) is adapted to produce shape birefringence

12. A polarisation beam splitter/combiner according to any preceding claim, wherein one of the branch portions (5, 6) is subjected to tensile stress and the other branch portion is subjected to compressive stress.

13. A polarisation beam splitter/combiner according to any preceding claim, wherein the substrate (2) is a SOI (silicon-on-insulator) substrate.

14. A polarisation beam splitter/combiner according to any preceding claim, wherein the stress-controlling means includes a stress-inducing coating (7) formed of silicon nitride.
